(19) United States
(12) Patent Application Publication
(10) Pub. No.: US 2006/0245403 A1
(43) Pub. Date: Nov. 2, 2006

(54) UPnP mobility extension using session initiation protocol

(75) Inventor: Brijesh Kumar, Princeton Junction, NJ (US)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/116,048

(22) Filed: Apr. 27, 2005

(51) Int. Cl. H04Q 7/24

(52) U.S. Cl. 370/338; 370/401; 370/352

(57) ABSTRACT

A mobility architecture is provided for use in a home network environment. The architecture includes: a mobile network device configured to remotely register with the home network upon attaching to a different network environment; a mobility support server operable to establish an address link between the mobile device and other network devices associated with the home network upon receipt of a remote registration request from the mobile network device; and a SIP server which cooperatively operates with the mobility support server to forward messages between the mobile device and the other network devices using a Session Initiation Protocol (SIP).

### FIELD OF THE INVENTION

The present invention relates to transient network devices and, more particularly, to an UPnP mobility enabled architecture which employs session initiation protocol.

### BACKGROUND OF THE INVENTION

UPnP is a well-known protocol designed to provide a number of essential services between consumer electronics devices (CE) especially within home environments. With UPnP, consumer devices can discover other devices on the network and can interact dynamically with each other either by controlling the discovered devices or passively by getting information on the status of the discovered devices.

In a home gateway environment, several appliances such a TV, a mobile phone, a PDA, a camcorder etc. can interoperate through the use of an UPnP architecture. Thus, they can make themselves present to each other, inform the rest about their functionalities and finally respond to different control mechanisms. However, UPnP is designed to operate with devices that are on the same IP sub network. Although the UPnP architecture leverages existing standards such as TCP/IP, HTTP and XML, it cannot directly handle scenarios where an UPnP device becomes mobile, and its IP attachment point moves outside a local area network.

Therefore, it is desirable to provide an architecture, which supports device mobility.

### SUMMARY OF THE INVENTION

In accordance with the present invention, a mobility architecture is provided for use in a home network environment. The architecture includes: one or more mobile network devices configured to remotely register with the home network upon attaching to a different network environment; a mobility support server operable to establish an address link between the mobile device and other network devices associated with the home network upon receipt of a remote registration request from the mobile network device; and a SIP server which cooperatively operates with the mobility support server to forward messages between the mobile device and the other network devices using a Session Initiation Protocol (SIP).

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a diagram of an exemplary architecture which supports device mobility according to the principles of the present invention;

FIG. 2 is a block diagram of a mobile device configured in accordance with the present invention;

FIG. 3 illustrates an exemplary data structure for a mobility binding database;

FIG. 4 illustrates an exemplary data structure for a forwarding rules database;

FIG. 5 is a timing diagram illustrating UPnP message forwarding in accordance with the present invention; and

FIGS. 6-9 illustrate different UPnP life-cycle scenarios in the context of the mobility architecture of the present invention.

### DETAILED DESCRIPTION OF THE PREFERRED EMBODIMENTS

UPnP is a well-known plug-and-play protocol that helps to automate networking of devices in a network environment. The UPnP protocol defines three basic abstractions: devices, services, and control points. A UPnP device can be any entity on a network that implements the protocols required by the UPnP architecture. The UPnP standardizes the protocols through which a device communicates, rather than the application programming interfaces that are used to connect to the device. Thus, a device that speaks the required protocols is a UPnP device.

A UPnP service is a unit of functionality implemented by a device. A device can implement zero or more services. Each service is typically defined as a set of methods or actions, each with a set of optional input and output parameters and an optional return value. In general, a given device type will have a set of required services that the device must implement. For example, a CD player would have a service that provides the ability to play, stop and pause the audio content.

A UPnP control point is an entity on the network that invokes the functionality provided by a device. One can think of the control point as a client and the device as the server.

The UPnP protocol provides a framework whereby control points can discover devices, invoke actions on a device's services and subscribe to events. Devices, on the other hand, respond to control point messages by invoking actions and sending events when state variables change. To support this basic interaction between control point and device, all UPnP devices adhere to the following phases of operation:
Addressing: When a UPnP device joins the network, it acquires a unique address. Addressing is usually accomplished by the use of DHCP or Auto-IP.
Description: The device uses XML to summarize its services and the capabilities of each service. Each device has its basic information such as the manufacturer, model number and description and so on. It also has a list of services that are available as well as information on how to invoke them by accessing the necessary URL.
Discovery: The UPnP device is found by control points and the device's information is being retrieved. The discovery of UPnP devices is accomplished by SSDP, which has been designed as a simple discovery solution for HTTP based resources on the LAN. It does not require any configuration, management or administration.
Control: The device handles all requests from the control points in order to invoke actions requested. The control protocol used between UPnP control points and devices is SOAP which also brings together HTTP for transport and XML for content to provide a web-based messaging and remote procedure mechanism.
Eventing: The device's services notify registered control points of any changes in the internal states. GENA is the protocol used by UPnP control points and devices to implement eventing. It follows the publisher/subscriber model. A control point has to subscribe to a device in order to receive notifications regarding the services it provides.
Presentation: The device may provide an HTML interface to allow friendlier administrative monitoring and control. This is an optional feature.
   However, as noted above, UPnP cannot handle the transition of a device from a local area network (LAN) to a wide area network (WAN). While the UPnP protocol has currently gained industry-wide favor, it is envisioned that other plug-and-play protocols may be developed to either expand upon or replace the UPnP protocol in the future, and thus fall within the scope of the present invention.

The Session Initiation Protocol (SIP) is a lightweight signaling protocol used for establishing, modifying and terminating sessions in an IP network, with a session ranging from a simple two-way telephone call to a collaborative multi-media conference. It is a text-encoded protocol based on elements from the HTTP. SIP can be used to initiate sessions as well as invite members to sessions that have been advertised and established by other means. Sessions can be advertised using multicast protocols such as SAP, electronic mail, news groups, web pages or directories (LDAP), among others.

There are three main elements in a SIP network:
User Agents (UA): UA's are the end devices in a SIP network. They originate all requests to establish media sessions and send and receive media. A UA could be located on a PC, a mobile phone, PDA etc. and usually consist of two parts; a UA Client (UAC) for sending requests and a UA Server (UAS) for responding to requests.
Servers: They are intermediary devices that are located within the SIP network and they can be categorized in three types; SIP Proxies, Redirect Servers and Registrar Servers. Proxies only forward SIP requests between all other SIP entities. Redirect Servers deal with redirections of requests in case a SIP entity is not available. Finally Registrar Servers enter and update UA's registration information on a Location Server.
Location Servers: These are usually a database that maintains information about users, such as URLs, IP Addresses, script and other additional preferences.

SIP is independent of any media used by the applications and is able to negotiate media used within sessions. Any multimedia application (games, distance learning application) can use SIP to set up sessions. In addition, SIP is not tied to any transport protocol. This aspect will minimize efforts to interoperate with new third generation networks. SIP is able to act as an “umbrella”, enabling sessions to be established between many different communications devices, offering services such as video-conferencing and instant messaging. It should be noted that SIP works on both IPv4 and IPv6.

SIP can be easily extended by the creation of new methods and headers, since not the whole SIP framework needs to be updated to handle the changes. Most of the servers will redirect in the same way the SIP requests and only the SIP UA's will have to handle the alterations. SIP also provides secure mechanisms and encryptions to protect for data replay or any other malicious behavior from unknown sources. This is vital over a WAN which is also a feature missing from UPnP.

IP networking assumes that a node's IP address uniquely identifies the node's point of attachment to the Internet. Therefore, a node must be located on the network indicated by its IP address in order to receive datagrams destined for it; otherwise, datagrams destined for the node would be undeliverable. For a mobile UPnP device, this problem may be addressed by creating a virtual instance of the device on its home network. Using SIP, this virtual instance of the mobile device is then linked to the actual physical instance of the mobile device which may be attached to a network outside of the home network. The virtual instance of a mobile device represents conditional presence of a mobile device (or control point) on the home network subject to several criteria as further explained below.

When away from its home network, the mobile device will acquire a “care-of address” to connect to the network. This new address reflects the mobile node's current point of attachment to a network outside of its home network. When a mobile device moves away from its home network, it must recognize this movement by some means. One simple means is to check the domain name or identity of router on the current network.

Upon detecting movement away from the home network, the mobile device registers itself with a SIP Server (UAS) running on its home gateway. A SIP user agent residing on the mobile device updates its current location at its home gateway. This event in turn triggers the creation of the virtual device instance on the home network. A logical link between this virtual device instance and the physical device is maintained, thereby enabling UPnP messages and events to be sent between the virtual device instance and the physical device as will be further described below.

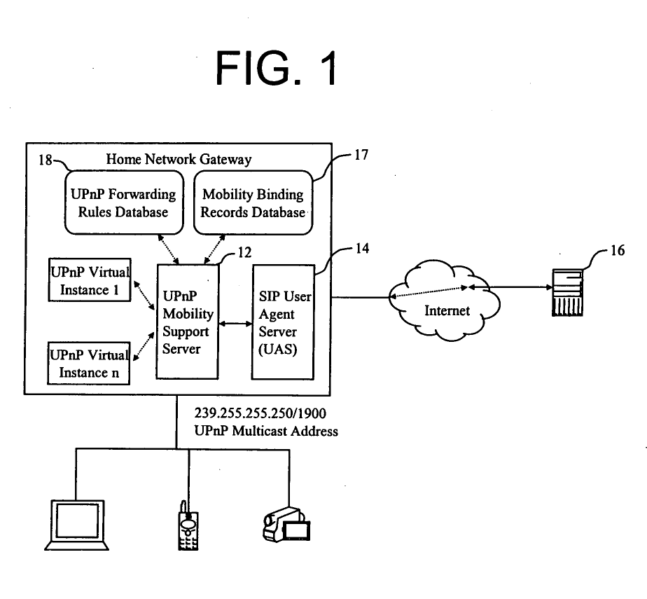

An exemplary architecture which supports device mobility according to this principle of the present invention is further described in relation to FIG. 1. The exemplary architecture is generally comprised of a UPnP mobility support server 12, a SIP server 14 and at least one mobile UPnP device 16. For illustration purpose, this architecture is described in the context of a home gateway environment, such that the mobility support server and SIP server may reside on the gateway device acting as the access point to the home network. However, it is readily understood that this architecture is also suitable for use in other local area networking environments.

When a new device attaches itself to the home network, it will NOTIFY (SSDP on HTTPMU) itself on the network so other UPnP devices including any control points know of its existence. While the UPnP device is still in the home network, no special processing is required and the behavior of all UPnP devices is as specified by the UPnP standards.

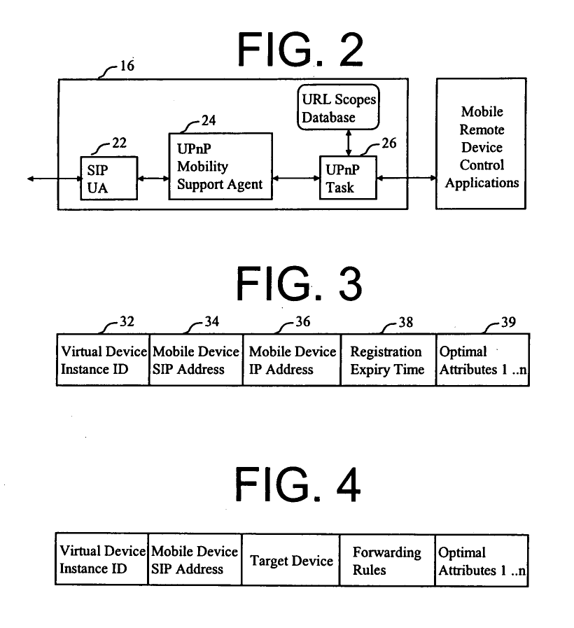

To support mobility, each mobile device 16 configured with a SIP User Agent (UA) 22, a UPnP mobility agent 24 and at least one UPnP service 26 as shown in FIG. 2. When the mobile device 16 moves out of its home network, it needs to register with its home gateway. The mobility agent is responsible for registration of the mobile node with the home gateway as well as maintaining needed tunneling information for forwarding messages between its current network location and the home network.

Upon attaching to a remote network, the mobile device 16 obtains a new IP address on the remote network. This address is assigned by a suitable mechanism, such as DHCP. The mobile device then registers its new address location with its home network.

In the exemplary embodiment, the mobility agent 24 effectuates a SIP registration of the device with the SIP server 14 on its home gateway. Thus, the mobility agent 24 is presumed to know the SIP address for its home network. The SIP address may have been input by a device operator or it may have been learned during device attachment to the home network.

In the home gateway environment, the mobility support server 12 is responsible for maintaining tunneling information for forwarding messages to and from a mobile UPnP device 16. Therefore, the mobility support server 12 maintains a data store 17 linking the mobile devices current IP address with a virtual address in the home network. This mobility binding database 17 maintains the binding information necessary to forward messages from the virtual instance to device as shown in FIG. 3. This database lets a virtual device to know the SIP identity of the corresponding mobile device, and its location.

For each mobile device, the mobility binding database 17 maintains a record of four key data items needed for protocol operation: an internal instance id and address of the corresponding virtual device instance 32, an external SIP address of the mobile device 34, an IP contact address for the mobile device 36, and a refresh time 38 which indicates the duration for which a virtual device to physical binding is valid. An implementation can optionally keep track of more session related parameters 39 such as number of UPnP packets forwarded in each direction, information about any security association such as security key and algorithm used, URL mapping schemes (explained later) used in each direction etc. A binding record in the database is created when the device registers and is destroyed when a mobile device deregisters. If a mobile device does not refresh its registration information before its current SIP registration expires, the binding information will be deleted at the end of the refresh time period.

In addition to the mobility binding database record maintained for the mobile device, UPnP mobility server can optionally maintain information regarding regular network events to be forwarded from UPnP devices in the home network to the mobile device. During registration with the SIP server, the mobile device indicates its preference for forwarding frequently generated events using a new “remote message forwarding preference” attribute in a UPnP message. This attribute indicates whether all internal events related to devices joining or leaving the home network in the form of UPnP application packets should be forwarded to the mobile device, or the mobility server should apply necessary filtering to reduce the amount of the traffic being forwarded to the mobile device. The procedure to reduce traffic from the devices inside the home to a mobile device is described later.

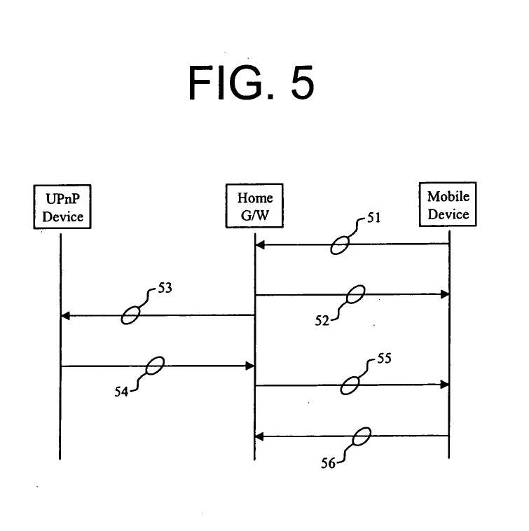

Referring to FIG. 5, the mobility support server 12 may serve as the proxy between the mobile device 16 and another device 19 residing on its home network. In this example, UPnP messages may be sent between the devices using the SIP MESSAGE mechanism. A new message type for supporting the transport of UPnP messages is further described below.

Different techniques may be employed to encapsulate UPnP messages into a SIP request. For example, SIP requests may contain a Multipurpose Internet Mail Extension (MIME) encoded message body, where MIME specifies a standard format for encapsulating multiple pieces of data into a single Internet message. The proposed architecture introduces a new MIME type to identify the recipient of the SIP MESSAGE request, where the new MIME type (e.g., “application/upnp”) is indicative of transporting UPnP messages between a SIP UA and a SIP Server. New MIME types have no effect on the proxies, since forwarding of the messages does not need to know what it is being carried, but rather where is it coming from and where is it going to. However, the new MIME type needs to be registered so that all devices know of this new type. It is readily understood that other techniques for encapsulating UPnP messages are also within the broader aspects of the present invention.

When a request from a mobile device 16 is received 51 at the home network, the SIP server acknowledges receipt of the request as indicated at 52. To identify the MIME type, the SIP request is parsed by the SIP server. SIP requests having the new MIME type are then forwarded on to the mobility support server for further processing. The UPnP mobility support server 12 may then further parse the UPnP message encapsulated within the SIP request. In addition, the UPnP mobility support server reformulates the UPnP message to appear as if it was the originator of the message and sends the reformulated UPnP message at 53 to the applicable UPnP devices within the home network.

For an application to use a new MIME type, both end points of communication must indicate the support of this feature. For example, before sending a UPnP message using the new mime type, the UPnP mobility server would like to know if the SIP UA on the mobile device has the capabilities necessary to receive the message. To do that, the UPnP mobility agent can either query a local database maintained at some home server which holds such information, or a mobile device can indicate support of this capabilities in its SIP registration message using the “Accept” header field. A mobile device can convey this capability in SIP REGISTER requests by setting the Accept header field to “application/upnp”.

When a response is sent back to the mobility support server 12 at 54, it encapsulates the UPnP message into a SIP message in a similar manner. The SIP message is formatted using the address linkage information for the intended mobile device as maintained by the mobility support server 12. The SIP server then forwards the SIP message at 55 to the mobile device. An acknowledgement may be received from the mobile device as shown at 56.

At the mobile device, the SIP message is received by the SIP UA which in turn parses the SIP message to identify the MIME type. SIP messages having the new MIME are forwarded by the SIP UA to the mobility agent. The mobility agent may further parse the SIP message to extract the encapsulated UPnP message. Finally, the UPnP message is passed along to the appropriate UPnP service residing on the mobile device. In this way, UPnP messages are sent between the mobile device and other devices attached to its home network.

In an exemplary approach, the mobility support server instantiates a virtual device instance for each mobile device. When registering with the home network, the mobile device will indicate if it has a lease on any IP address on the home network or if it has a permanently allocated IP address on the home network. In either case, a virtual device instance will be created with the IP address previously assigned to the device; otherwise, a virtual device instance will be created using any available IP address. In an alternative approach, the IP address for the mobility support server may act as a virtual address for each mobile device.

To create a virtual device corresponding to a physical device, the virtual device needs to have an IP address assigned. IP addresses are typically allocated on a network by a DHCP server. DHCP server is responsible for allocating addresses to any device that joins the network, and controlling the lease duration for an allocated address. If the physical device had a previously assigned address then its lease is renewed with the DHCP server. If the mobile device indicated no previously assigned address, a new address is allocated by sending an address assignment request to the DHCP server. However, if network devices use IPv6 addresses, and use stateless IPv6 address configuration instead of DHCP, then IPv6 standard defined stateless address assignment procedures are used. The stateless address assignment procedure in IPv6 requires a node to assign a self generated IPv6 address to an interface and then perform a duplicate address detection to make sure that no other node is using that address, before using that address for any communication.

UPnP messages intended for the mobile device are intercepted by its virtual device instance at the home gateway. Intercepted messages are in turn passed on to the UPnP mobility support server. The mobility support server then refers its mobility binding cache database. It then determines the corresponding SIP address of the physical mobile device, and ensures that the device registration has not expired. After doing the packet transformation described below, UPnP mobility server tunnels the UPnP messages via the SIP server to the mobile device.

A number of UPnP messages carry Universal Resource Locators (URLs) for Control, Description or Event Notifications delivery. A URL specifies a resource by specifying its location rather than identifying the resource by name or some other attribute. In the context of UPnP architecture, a ControlURL is the where control points post requests to control a particular device and its service. The EventSubURL is where control points post requests to subscribe to events. The DescriptionURL tells the control points the location from which they can retrieve the service description document. Both in IPv4 and IPv6, these URLs may correspond to IP addresses in the private domains, and hence cannot be accessed from the outside. To ensure that the mobile device can send or receive the information to and from these URLs, two approaches are proposed: a) tunneling over SIP, and b) URL mapping. These two approaches are discussed in the next paragraph.

In the tunneling approach, a mobile device tunnels any http request to send or receive data to and from these internal URLs using the SIP protocol by carrying these requests as payload in the SIP messages. In the URL mapping approach, the internal URLs are mapped to suitable externally accessible URLs before an UPnP packet is sent to the mobile device. The UPnP Mobility agent keeps track of mapping between internal URLs and external URLs in a local database. If this URL mapping approach is followed, the mobile device can send the request to get or send data to these URLs in HTTP request to the home gateway directed at externally visible URLs without the need to tunnel these HTTP requests via SIP. UPnP mobility server receives all these requests, and using its internal mapping table generates suitable HTTP message to the device inside the home network using corresponding internal URLs. Once it gets the data, it can forward this to the mobile device over HTTP.

Likewise, UPnP messages generated at the mobile device are intercepted by its virtual device instance at the home gateway. The devices on the home network do not see any difference between physical device and the virtual device since a device is identified by its unique IP address. Specifically, SIP messages encapsulating the UPnP messages are received by the SIP server which after recognizing the new UPnP mime type hands over the message to UPnP mobility server. The mobility support server refers to its device binding cache data and passes the message to the applicable virtual device instance. The virtual device instance makes appropriate address changes so that it appears to the local devices as if the message came from a local UPnP device or control point. The virtual device instance then forwards the messages to local device in the home network. Since UPnP uses multicast messages for all discovery and eventing, it is understood that the mobility support server will register itself as a multicast receiver for all those devices for which it has instantiated any virtual instance.

UPnP operation requires generation of a large number of multicast messages between devices to search services and to declare arrival or departure of certain devices. The UPnP service discovery protocol, Simple Service Discovery Protocol (SSDP) uses HTTP Multicast messages sent to the address 239.255.255.250:1900, which is SSDP's reserved multicast address. A header field, Search Target (ST), identifies the search target. Since these multicast searches do not provide reliability, each device multicasts these messages several times to ensure that all devices receive these messages. The forwarding of all these multicast messages to the mobile will consume unnecessary bandwidth.

A mechanism is proposed to control forwarding of these messages. When a mobile device registers with the SIP server, it can specify its message filtering policies to the UPnP mobile server. Alternatively, such a policy can be pre-configured on the UPnP mobility support server by the user before leaving the home network. The mobile support server maintains this information in the forwarding policy database. This forwarding policy database is also accessible to a virtual device instance. An exemplary data structure for this data store is shown in FIG. 4.

For example, a mobile device may request that only search messages from a certain class of devices be forwarded to it. A target device data element is used to specify the desired class of devices. An exemplary syntax for this data element is shown is the following table.

| Target Device Values | Syntax |
|---|---|
| All Devices: | All |
| Root Device: | rootdevice, |
| Specific Devices: | uuid: device-uuid |
| Devices of a Specific Type: | urn:schemas-upnp- |
| | org:device:devicetypeversion |
| Services of Specific type: | urn:schemas-upnp- |
| | org:service:serviceTypeversion |

Moreover, all SSDP search messages looking for the services need not be forwarded to the mobile device. Instead, the virtual device itself can respond to the services available on the mobile device. Even if no forwarding policy is specified, only one instance of a SSDP message can be forwarded rather than forwarding multiple copies of the same message over wide area networks. The similar optimization can be applied to events generated by the devices on the home networks. For example, a mobile device can specify that it is only interested in events from a sub-set of devices. Hence, only the SSDP messages indicating arrival or departure of a small sub-set of the devices meeting the mobile specified selection criteria are forwarded to the mobile device. Such a filtering approach will substantially reduce the amount of data being forwarded over the network.

If a mobile device wants to return to the home network, it must first de-register itself with the home gateway. This will destroy the corresponding virtual device instance and UPnP messages will no longer be forwarded to the mobile device. The mobile device will also be de-registered if SIP session registration expires due to lack of session refresh by the mobile device.

As mentioned earlier, when a UPnP device moves away from the home network an addressing problem arises. The UPnP discovery messages include the description and control URL's of the UPnP devices. For a mobile device, these addresses will not be at a local address for the devices at home. Assuming that URLs included are global address, this should cause no problem. However, the addresses included in the messages from home devices will be local addresses. A mobile UPnP device cannot directly access these URLs since they are in different domain. It is important that a mobile device must interpret these URLs as special kind of SIP tunneled URLs, unless the UPnP mobility server has using a new UPnP message option has indicated that these URLs are global URLs to the mobile device. We propose a new UPnP packet field called “URL Scope.” The URL scope will have one of two values (Global or Local) assigned. This information would be inserted into UPnP messages by the UPnP mobility support server in every UPnP message forwarded to the mobile device. On the device side, UPnP mobility agent will remove this field to maintain compatibility with standard UPnP message formats, and instead indicate this information to UPnP application using some implementation dependent mechanism. All Http Get requests to non-global URLs must be routed through UPnP mobility agent so that these requests get delivered via SIP tunnel to the virtual instance of the devices.

The mobility architecture of the present invention is better understood in the context of different UPnP life-cycle scenarios. Therefore, four typical life-cycle scenarios are further described below. For simplicity, it is assumed that addressing, description and presentation are dealt with by the device manufacturer, where the UPnP specification should be followed. In addition, it is understood that the home gateway includes the UPnP mobility support server 12 and the SIP server 14 as described above.

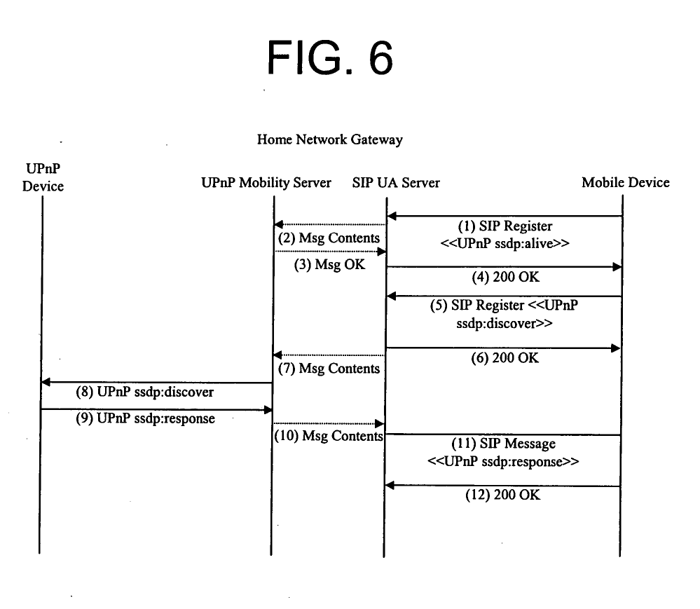

A UPnP device discovery scenario is further described in relation to FIG. 6. A mobile device first registers with the SIP server on the home gateway (1). This results in the SIP server passing the initial contents of the message to UPnP mobility server (2), which will at this point initialize a virtual device instance corresponding to the mobile device. Once the UPnP mobility server completes the operation, it signals SIP server (3) to send a 200 OK message to the mobile device (4). At this point, the mobile device decides to search for any devices located at the home network, it creates a SIP MESSAGE request and in its body, it attaches an SSDP Discovery Request (ssdp: discover) using the proposed mime type in this disclosure (5). The SIP server as soon as it receives the message it dispatches a 200 OK message (6), and passes the contents to the UPnP mobility support server (7). The mobility server will then pass this message to the virtual instance of the device. The virtual instance then sends out a multicast SSDP discovery request (8) to the devices in the home network. Once a device or service detects that it is being searched for, it responds with a unicast message directly to the sender (9). The virtual instance of the device will capture the UPnP SSDP Discovery Response messages. It will pass these messages to UPnP Mobility support server by making the necessary changes to URLs. The UPnP Mobility Server then passes the contents to the SIP server (10). AT this point, the SIP server creates a SIP MESSAGE request which encapsulates the UPnP related information (11). For every received message, the mobile device issues a 200 OK response (12).

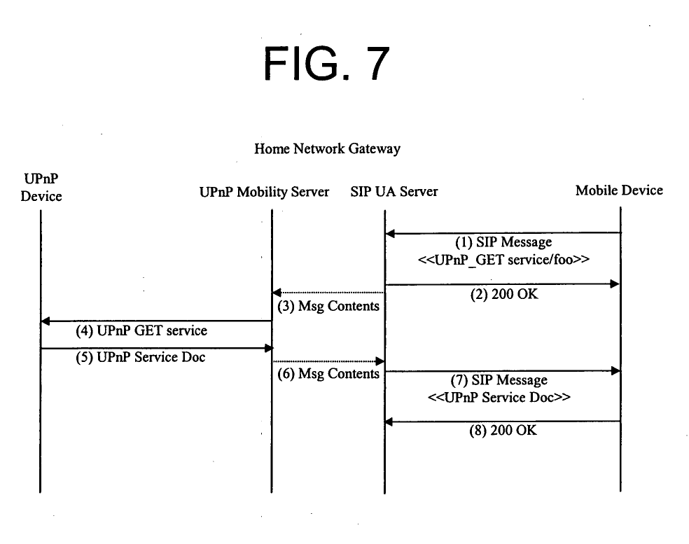

FIG. 7 illustrates a UPnP Service description discovery scenario. After an UPnP control point (e.g., the a mobile device) discovers a device, it has only the information contained in the discovery message—the device type, its universally unique identifier, and a URL to its description document. To find out more about the device, including its services and actions it supports, the control point retrieves description documents from the device. When the mobile device decides to retrieve device/service information search for any UPnP device located at the home network, it creates a SIP MESSAGE request and in its body it creates a GET HTTP request using the mime type proposed in this document (1). The SIP Server as soon as it receives the message it dispatches a 200 OK message (2), and passes the contents to UPnP mobility support server (3). The UPnP mobility support server hands over this message to the virtual instance of the device. At this point, the virtual instance of the mobile device retrieves more information about the services of the device, by sending out a HTTP GET request to the device (4). Once a device or service receives the request, it responds with a unicast message directly to the sender (5). The virtual instance of the device will pass these messages to UPnP Mobility support server by making the necessary changes to URLs. The UPnP Mobility Server then passes the contents to the SIP server (6). At this point, the SIP server creates a SIP MESSAGE request which encapsulates the UPnP related information (7). For every received message, the mobile device issues a 200 OK response (8).

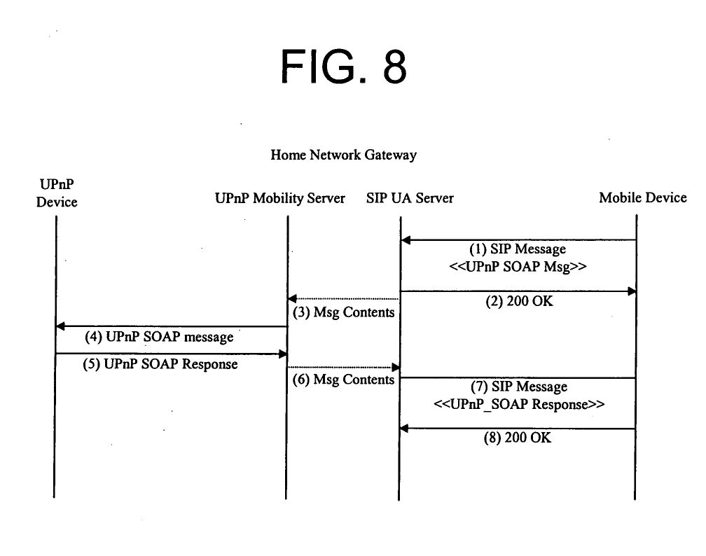

Let us assume that the mobile device wants to send a SOAP message to invoke an action on a UPnP device at the home network. Referring to FIG. 8, the mobile device has to create a SIP MESSAGE request and in the body it will enclose the UPnP SOAP request (1). The SIP Server will issue a 200 OK message to acknowledge that the message has been received (2). The SIP server then passes the UPnP message from the body of the SIP MESSAGE to the Mobility support server (3). The mobility support internally hands over the message to the virtual instance of the device, which then sends it to the relevant UPnP device (4). After the request is processed, a response is being returned to the virtual instance of the mobile device (5). The UPnP Mobility Server then passes the contents to the SIP server (6). At this point, the SIP server creates a SIP MESSAGE request which encapsulates the UPnP related information and sends back to the mobile device (7). For every received message, the mobile device issues a 200 OK response (8).

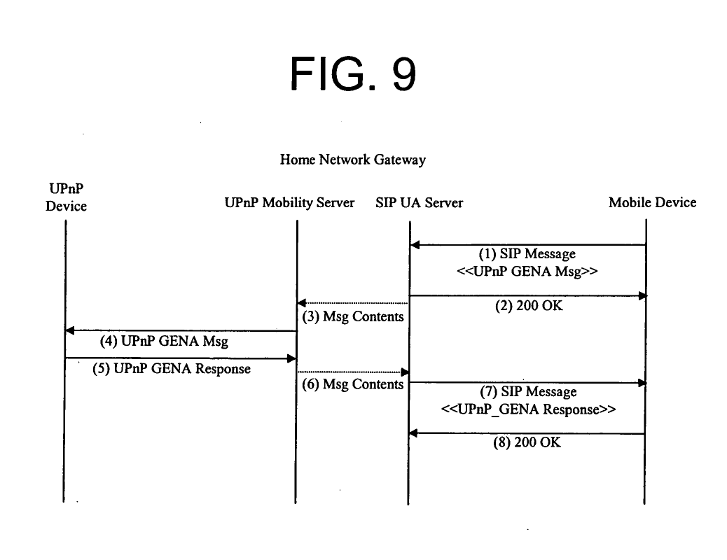

FIG. 9 illustrates events an UPnP eventing scenario. UPnP eventing allows a mobile device to subscribe to events from certain devices. The mobile device has to create a SIP MESSAGE request and in the body it will enclose the UPnP GENA request (1). The SIP Server will issue a 200 OK message to acknowledge that the message has been received (2). The SIP server then passes the UPnP message from the body of the SIP MESSAGE to the mobility support server (3). The mobility support internally hands over the message to the virtual instance of the device, which then sends it to the relevant UPnP device (4). After the request is processed, a response is being returned to the virtual instance of the mobile device (5). The UPnP Mobility Server then passes the contents to the SIP server (6). At this point, the SIP server creates a SIP MESSAGE request which encapsulates the UPnP related information and sends back to the mobile device (7). For every received message, the mobile device issues a 200 OK response (8).

Exemplary UPnP and SIP messages for each of these different life-cycle scenarios are found in the appendix below.

The description of the invention is merely exemplary in nature and, thus, variations that do not depart from the gist of the invention are intended to be within the scope of the invention. Such variations are not to be regarded as a departure from the spirit and scope of the invention.

### APPENDIX

UPnP Discovery Scenario (SSDP-SIP)

G/W Multicast SSDP Discovery Request

M-SEARCH * HTTP/1.1

Host: 239.255.255.250:1900

Man: ssdp:discover

MX: 3

ST: ssdp:all

SSDP Discovery Response

HTTP/1.1 200 OK

Location: http://192.168.0.1:2869/upnphost/udhisapi.dll?content=uuid:6859ddde-89cd-46df-bab8-1394523aec23

Ext:

USN: uuid:6859ddde-89cd-46df-bab8-1394523aec23: :urn:schemas-upnp-org:device:AudioPlayer:1

Server: Linux-Mandrake/8 UPnP/1.0 UPnP-Device-Host/1.0

Cache-Control: max-age:1800

ST: urn:schemas-upnp-org:device:AudioPlayer:1

Content-Length:0

Mobile Device SSDP Discovery Request

MESSAGE sip: homegw@homedomain.com SIP/2.0

Via: SIP/2.0/TCP

mobiledevice.foreigndomain.com;branch=z9hG4bK776sgdkse

Max-Forwards: 70

From: sip: mobiledevice@foreigndomain.com;tag=49583

To: sip: homegw@homedomain.com

Call-ID: asd88asd77a@1.2.3.4

CSeq: 1 MESSAGE

Content-Type: application/UPnP

Content-Length: 74

M-SEARCH * HTTP/1.1

Host: 239.255.255.250:1900

Man: ssdp:discover

MX: 3

ST: ssdp:all

Notification Response from Home gateway

SIP/2.0 200 OK

Via: . . .

Via: SIP/2.0/TCP

mobiledevice.foreigndomain.com;branch=z9hG4bK776sgdkse; received=1.2.3.4

From: sip: mobiledevice@foreigndomain.com;tag=49394

To: sip: homegw@homedomain.com;tag=ab8asdasd9

Call-ID: asd88asd77a@1.2.3.4

CSeq: 1 MESSAGE

Content-Length: 0

SIP MESSAGE to Mobile Device

MESSAGE sip:mobiledevice@foreigndomain.com SIP/2.0

Via: SIP/2.0/TCP homegw.domain.com;branch=z9hG4bK776sgdkse

Max-Forwards: 70

From: sip:homegw@homedomain.com;tag=49583

To: sip:mobiledevice@foreigndomain.com

Call-ID: asd88asd77a@1.2.3.4

CSeq: 1 MESSAGE

Content-Type: application/UPnP

Content-Length: 228

HTTP/1.1 200 OK

Location:

http://192.168.0.1:2869/upnphost/udhisapi.dll?content=uuid:6859ddde-89cd-46df-bab8-1394523aec23

Ext:

USN: uuid:6859ddde-89cd-46df-bab8-1394523aec23: :urn:schemas-upnp-org:device:AudioPlayer:1

Server: Linux-Mandrake/8 UPnP/1.0 UPnP-Device-Host/1.0

Cache-Control: max-age:1800

ST: urn:schemas-upnp-org:device:AudioPlayer:1

Content-Length:0

SIP Response from Mobile Device

SIP/2.0 200 OK

Via: . . .

Via: SIP/2.0/TCP homegw.homedomain.com;branch=z9hG4bK776sgdkse; received=1.2.3.4

From: sip: homegw@homedomain.com;tag=49394

To: sip: mobiledevice@foreigndomain.com;tag=ab8asdasd9

Call-ID: asd88asd77a@1.2.3.4

CSeq: 1 MESSAGE

Content-Length: 0

UPnP Service Retrieval Scenario (HTTP-SIP)

G/W Service Discovery Request

GET device/AudioPlayer HTTP/1.1

Host 192.168.0.1:8000

Accept-Language: en, fr, ge, gr

(blank line)

UPnP Service Discovery Response

HTTP/1.1 200 OK

Content-Language: en, fr, ge, gr

Content-Length:

Content-Type: text/xml

Date:

```
<?xml version=“1.0”?>
<root xmlns=“urn:schemas-upnp-org:device-1-0”>
  <specVersion>
    <major>1</major>
    <minor>0</minor>
  </specVersion>
  <URLBase>http://192.168.0.1</URLBase>
  <device>
    <deviceType>urn:schemas-upnp-org:device:Audio:2</deviceType>
    <friendlyName>Audio Player</friendlyName>
    <manufacturer>Panasonic</manufacturer>
    <manufacturerURL>http://www.panasonic.com</manufacturerURL>
    <modelDescription>Audio Player Audigy 640g</modelDescription>
    <modelName>Audigy</modelName>
            <modelNumber>640g</modelNumber>
    <modelURL> http://www.panasonic.com/AudioPlayer</modelURL>
    <serialNumber>0123456789</serialNumber>
    <UDN>uuid: 00-26-54-12-1F-A5 </UDN>
    <UPC>123456789123</UPC>
    <iconList>
      <icon>
        <mimetype>image/jpg</mimetype>
        <width>16</width>
        <height>16</height>
        <depth>32</depth>
        <url>http://192.168.0.1/icon.jpg</url>
    </icon>
    <!-- XML to declare other icons, if any, go here -->
    </iconList>
    <serviceList>
      <service>
        <serviceType>urn:schemas-upnp-org:service:serviceType:v</serviceType>
        <serviceId>urn:upnp-org:serviceId:1</serviceId>
        <SCPDURL> http://192.168.0.1/services/1/description.html</SCPDURL>
        <controlURL>http://192.168.0.1/services/1/control.html</controlURL>
        <eventSubURL>
http://192.168.0.1/services/1/eventing.html</eventSubURL>
      </service>
      <!-- Declarations for other services defined by a UPnP Forum working
          committee (if any) go here -->
      <!-- Declarations for other services added by UPnP vendor (if any) go here --
>
    </serviceList>
    <deviceList>
      <!-- Description of embedded devices defined by a UPnP Forum working
          committee (if any) go here -->
      <!-- Description of embedded devices added by UPnP vendor (if any) go here
-->
    </deviceList>
    <presentationURL> http://192.168.0.1/presentation.html</presentationURL>
  </device>
</root>
```

SIP MESSAGE from Mobile Device

MESSAGE sip:mobiledevice@foreigndomain.com SIP/2.0

Via: SIP/2.0/TCP homegw.domain.com;branch=z9hG4bK776sgdkse

Max-Forwards: 70

From: sip:homegw@homedomain.com;tag=49583

To: sip:mobiledevice@foreigndomain.com

Call-ID: asd88asd77a@1.2.3.4

CSeq: 1 MESSAGE

Content-Type: application/UPnP

Content-Length: 76

GET device/AudioPlayer HTTP/1.1

Host 192.168.0.1:8000

Accept-Language: en, fr, ge, gr

(blank line)

SIP Response from G/W

SIP/2.0 200 OK

Via: . . .

Via: SIP/2.0/TCP

mobiledevice.foreigndomain.com;branch=z9hG4bK776sgdkse; received=1.2.3.4

From: sip: mobiledevice@foreigndomain.com;tag=49394

To: sip: homegw@homedomain.com;tag=ab8asdasd9

Call-ID: asd88asd77a@1.2.3.4

CSeq: 1 MESSAGE

Content-Length: 0

SIP MESSAGE from G/W

MESSAGE sip: homegw@homedomain.com SIP/2.0

Via: SIP/2.0/TCP

mobiledevice.foreigndomain.com;branch=z9hG4bK776sgdkse

Max-Forwards: 70

From: sip: mobiledevice@foreigndomain.com;tag=49583

To: sip: homegw@homedomain.com

Call-ID: asd88asd77a@1.2.3.4

CSeq: 1 MESSAGE

Content-Type: application/UPnP

Content-Length: 1605

```
<?xml version=“1.0”?>
<root xmlns=“urn:schemas-upnp-org:device-1-0”>
  <specVersion>
    <major>1</major>
    <minor>0</minor>
  </specVersion>
  <URLBase>http://192.168.0.1</URLBase>
  <device>
    <deviceType>urn:schemas-upnp-org:device:Audio:2</deviceType>
    <friendlyName>Audio Player</friendlyName>
    <manufacturer>Panasonic</manufacturer>
    <manufacturerURL>http://www.panasonic.com</manufacturerURL>
    <modelDescription>Audio Player Audigy 640g</modelDescription>
    <modelName>Audigy</modelName>
          <modelNumber>640g</modelNumber>
    <modelURL> http://www.panasonic.com/AudioPlayer</modelURL>
    <serialNumber>0123456789</serialNumber>
    <UDN>uuid: 00-26-54-12-1F-A5 </UDN>
    <UPC>123456789123</UPC>
    <iconList>
      <icon>
        <mimetype>image/jpg</mimetype>
        <width>16</width>
        <height>16</height>
        <depth>32</depth>
        <url>http://192.168.0.1/icon.jpg</url>
    </icon>
    <!-- XML to declare other icons, if any, go here -->
    </iconList>
    <serviceList>
      <service>
        <serviceType>urn:schemas-upnp-org:service:serviceType:v</serviceType>
        <serviceId>urn:upnp-org:serviceId:1</serviceId>
        <SCPDURL> http://192.168.0.1/services/1/description/</SCPDURL>
        <controlURL>http://192.168.0.1/services/1/control/</controlURL>
        <eventSubURL> http://192.168.0.1/services/1/eventing/</eventSubURL>
      </service>
      <!-- Declarations for other services defined by a UPnP Forum working
          committee (if any) go here -->
      <!-- Declarations for other services added by UPnP vendor (if any) go here --
>
    </serviceList>
    <deviceList>
      <!-- Description of embedded devices defined by a UPnP Forum working
          committee (if any) go here -->
      <!-- Description of embedded devices added by UPnP vendor (if any) go here
-->
    </deviceList>
    <presentationURL> http://192.168.0.1/presentation.html</presentationURL>
  </device>
</root>
```

SIP Response from G/W

SIP/2.0 200 OK

Via: . . .

Via: SIP/2.0/TCP homegw.homedomain.com;branch=z9hG4bK776sgdkse; received=1.2.3.4

From: sip: homegw@homedomain.com;tag=49394

To: sip: mobiledevice@foreigndomain.com;tag=ab8asdasd9

Call-ID: asd88asd77a@1.2.3.4

CSeq: 1 MESSAGE

Content-Length: 0

UPnP Control Scenario (SOAP-SIP)

SIP MESSAGE to G/W from Mobile Device

MESSAGE sip: homegw@homedomain.com SIP/2.0

Via: SIP/2.0/TCP

mobiledevice.foreigndomain.com;branch=z9hG4bK776sgdkse

Max-Forwards: 70

From: sip: mobiledevice@foreigndomain.com;tag=49583

To: sip: homegw@homedomain.com

Call-ID: asd88asd77a@1.2.3.4

CSeq: 1 MESSAGE

Content-Type: application/U PnP

Content-Length: 389

POST/Stop HTTP/1.1

Host: 192.168.0.1/services/1/control.html

Content-Type: text/xml; charset“utf-8”

Contenct-Length:227

SOAPAction: http://192.168.0.1/services/1/control/Stop

```
<s:Envelope xmlns:s=http://www.w3.org/2001/06/soap-envelope/”
  s:encodingStyle=”http://www.w3.org/2001/06/soap-enoding/”>
  <s:Body>
    <u:Stop xmlns:u=”urn:schemas-upnp-org:service:control:1”>
    <Stop>1</Stop>
    </u:Stop>
  </s:Body>
</s:Envelope>
```

SIP Response from G/W

SIP/2.0 200 OK

Via: . . .

Via: SIP/2.0/TCP

mobiledevice.foreigndomain.com;branch=z9hG4bK776sgdkse; received=1.2.3.4

From: sip: mobiledevice@foreigndomain.com;tag=49394

To: sip: homegw@homedomain.com;tag=ab8asdasd9

Call-ID: asd88asd77a@1.2.3.4

CSeq: 1 MESSAGE

Content-Length: 0

SOAP Request from G/W to UPnP Device

POST/Stop HTTP/1.1

Host: 192.168.0.1/services/1/control.html

Content-Type: text/xml; charset“utf-8”

Contenct-Length:227

SOAPAction: http://192.168.0.1/services/1/control/Stop

```
<s:Envelope xmlns:s=http://www.w3.org/2001/06/soap-envelope/”
  s:encodingStyle=”http://www.w3.org/2001/06/soap-enoding/”>
  <s:Body>
    <u:Stop xmlns:u=”urn:schemas-upnp-org:service:control:1”>
    <Stop>1</Stop>
    </u:Stop>
  </s:Body>
</s:Envelope>
```

SOAP Response from UPnP Device to G/W

HTTP/1.1 200 OK

Contenct-Length:

Content-Type: text/xml; charset“utf-8”

Date:

Ext:

Server: Linux-Mandrake/8 UPnP/1.0 UPnP-Device-Host/1.0

```
<s:Envelope xmlns:s=http://www.w3.org/2001/06/soap-envelope/”
  s:encodingStyle=”http://www.w3.org/2001/06/soap-enoding/”>
  <s:Body>
    <u:Stop xmlns:u=”urn:schemas-upnp-org:service:control:1”>
    <Stop>1</Stop>
    </u:Stop>
  </s:Body>
</s:Envelope>
```

SIP MESSAGE to Mobile Device from G/W

MESSAGE sip: mobiledevice@foreigndomain.com SIP/2.0

Via: SIP/2.0/TCP homegw.homedomain.com;branch=z9hG4bK776sgdkse

Max-Forwards: 70

From: sip: homegw@homedomain.com;tag=49583

To: sip: mobiledevice@foreigndomain.com

Call-ID: asd88asd77a@1.2.3.4

CSeq: 1 MESSAGE

Content-Type: application/UPnP

Content-Length: 392

POST/Stop HTTP/1.1

Host: 192.168.0.1/services/1/control.html

Content-Type: text/xml; charset“utf-8”

Contenct-Length:227

SOAPAction: http://192.168.0.1/services/1/control/Stop

```
<s:Envelope xmlns:s=http://www.w3.org/2001/06/soap-envelope/”
  s:encodingStyle=”http://www.w3.org/2001/06/soap-enoding/”>
  <s:Body>
    <u:Stop xmlns:u=”urn:schemas-upnp-org:service:control:1”>
    <Stop>1</Stop>
    </u:Stop>
  </s:Body>
</s:Envelope>
```

SIP Response from Mobile Device

SIP/2.0 200 OK

Via: . . .

Via: SIP/2.0/TCP homegw.homedomain.com;branch=z9hG4bK776sgdkse; received=1.2.3.4

From: sip: homegw@homedomain.com;tag=49394

To: sip: mobiledevice@foreigndomain.com;tag=ab8asdasd9

Call-ID: asd88asd77a@1.2.3.4

CSeq: 1 MESSAGE

Content-Length: 0

UPnP Eventing Scenario (GENA-SIP)

Notification from UPnP Device

NOTIFY delivery 192.168.0.1 HTTP/1.1

Host: 192.168.0.1

Content-Type: text/xml

Content-Length: 143

NT: upnp:event

NTS: upnp:propchange

SID: uuid: 00-26-54-12-1F-A5

SEQ: 1

```
<e:propertyset xmls:e”urn:schemas-upnp-org:event-1-0”>
  <e:property>
    <Power>On</Power>
    <PowerSetting>8</PowerSetting>
  </e:property>
</e:propertyset>
```

Notification Response from Home gateway

HTTP/1.1 200 OK

SIP MESSAGE to Mobile Device

MESSAGE sip:mobiledevice@foreigndomain.com SIP/2.0

Via: SIP/2.0/TCP homegw.domain.com;branch=z9hG4bK776sgdkse

Max-Forwards: 70

From: sip:homegw@homedomain.com;tag=49583

To: sip:mobiledevice@foreigndomain.com

Call-ID: asd88asd77a@1.2.3.4

CSeq: 1 MESSAGE

Content-Type: application/UPnP

Content-Length: 228

NOTIFY delivery 192.168.0.1 HTTP/1.1

Host: 192.168.0.1

Content-Type: text/xml

Content-Length: 50

```
<Power>On</Power>
<PowerSetting>8</PowerSetting>
  </e:property>
</e:propertyset> NT: upnp:event
NTS: upnp:propchange
SID: uuid: 00-26-54-12-1F-A5
SEQ: 1
<e:propertyset xmls:e”urn:schemas-upnp-org:event-1-0”>
  <e:property>
```

SIP Response from Mobile Device

SIP/2.0 200 OK

Via: . . .

Via: SIP/2.0/TCP homegw.homedomain.com;branch=z9hG4bK776sgdkse; received=1.2.3.4

From: sip:homegw@homedomain.com;tag=49394

To: sip:mobiledevice@foreigndomain.com;tag=ab8asdasd9

Call-ID: asd88asd77a@1.2.3.4

CSeq: 1 MESSAGE

Content-Length: 0

What is claimed is:

1. A mobility architecture for a home network environment, comprising:
a mobile network device configured to register with a home network according to a plug-and-play protocol upon attaching thereto and operable to remotely register with the home network upon attaching to a different network environment;
a mobility support server residing in the home network and operable to establish an address link between the mobile device and other network devices associated with the home network upon receipt of a remote registration request from the mobile network device; and
a SIP server residing in the home network and cooperatively operates with the mobility support server to forward messages between the mobile device and the other network devices using a Session Initiation Protocol (SIP).

2. The mobility architecture of claim 1 wherein the mobile network device is configured to learn a SIP address for the home network and remotely register with the home network using the SIP address.

3. The mobility architecture of claim 1 wherein the mobility support server maintains a data store having an identifier for the mobile network device and a network address for the mobile network device in the different network environment.

4. The mobility architecture of claim 1 wherein the mobility support server is adapted to receive messages from the other network devices within the home network in accordance with the plug-and-play protocol and operable to encapsulate the messages into SIP requests.

5. The mobility architecture of claim 4 wherein the mobility support server translates the messages into a format according to Multipurpose Internet Mail Extensions (MIME).

6. The mobility architecture of claim 1 wherein the SIP server forwards messages to the mobile device using a SIP MESSAGE mechanism.

7. The mobility architecture of claim 1 wherein the SIP server is adapted to receive SIP messages from outside of the home network and direct SIP messages having a predefined mobility type to the mobility support server.

8. The mobility architecture of claim 7 wherein the mobility support server extracts messages encapsulated in the SIP messages and forward the messages to applicable network devices within the home network.

9. The mobility architecture of claim 1 wherein the mobile network device is configured to register with the home network in accordance with Universal Plug and Play (UPnP) protocol.

10. The mobility architecture of claim 1 wherein the mobile network device includes:
a SIP user agent;
a device service defined in accordance with the plug-and-play protocol; and
a forwarding task operable to forward messages between the SIP user agent and the device service.

11. A mobility architecture for a home network environment, comprising:
a mobile network device configured to register with a home network according to a plug-and-play protocol upon attaching thereto and operable to remotely register with the home network upon attaching to a different network environment;
a mobility support server residing in the home network and operable to create a virtual device instance in the home network upon receipt of a remote registration request from the mobile network device, where the virtual device instance forwards messages via the mobility support server between the mobile network device and other network devices associated with the home network; and
a SIP server residing in the home network, wherein the mobility support server interacts with the SIP server to forward messages outside of the home network using a Session Initiation Protocol (SIP).

12. The mobility architecture of claim 11 wherein the mobile network device is configured to learn a SIP address for the home network and remotely register with the home network using the SIP address.

13. The mobility architecture of claim 11 wherein the mobility support server maintains a data store having an identifier for the mobile network device and a network address for the mobile network device in the different network environment.

14. The mobility architecture of claim 1 wherein the mobility support server is adapted to receive messages via the virtual device instance from the other network devices within the home network in accordance with the plug-and-play protocol and operable to encapsulate the messages into SIP requests.

15. The mobility architecture of claim 14 wherein the mobility support server translates the messages into a format according to Multipurpose Internet Mail Extensions (MIME).

16. The mobility architecture of claim 11 wherein the SIP server forwards messages to the mobile device using a SIP MESSAGE mechanism.

17. The mobility architecture of claim 1 wherein the SIP server is adapted to receive SIP messages from outside of the home network and direct SIP messages having a predefined mobility type to the mobility support server.

18. The mobility architecture of claim 17 wherein the mobility support server extracts messages encapsulated in the SIP messages and forwards the messages to the virtual device instance for delivery to applicable network devices within the home network.

19. The mobility architecture of claim 1 wherein the mobile network device is configured to register with the home network in accordance with Universal Plug and Play (UPnP) protocol.
